(19) United States
(12) Patent Application Publication
(10) Pub. No.: US 2013/0254578 A1
(43) Pub. Date: Sep. 26, 2013

(54) COMPUTING DEVICE AND METHOD FOR MANAGING SERVERS IN DATA CENTER

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventor: JIA-QING HUANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/770,766

(22) Filed: Feb. 19, 2013

(30) Foreign Application Priority Data
Mar. 23, 2012 (CN) 201210078662.1

(51) Int. Cl. G06F 1/26

(52) U.S. Cl. CPC G06F 1/266
USPC 713/330

(57) ABSTRACT

In a method for managing servers in a data center, an peripheral BMC list of each candidate BMC is updated, when any candidate BMC receives a data packet from an peripheral BMC. A master BMC is determined from all of the candidate BMCs, and the master BMC sends starting instructions to each peripheral BMC at a specified time interval, according to a preset start sequence. Power supply devices corresponding to the master BMC and all the candidate BMCs are powered on after all of the power supply devices corresponding to the peripheral BMCs have been powered on, and all of the servers in the data center are started in this manner

### BACKGROUND

1. Technical Field

Embodiments of the present disclosure generally relate to data center management, and particularly to a computing device and a method for managing servers in a data center.

2. Description of Related Art

A data center includes a large number of servers, and each server includes a baseboard management controller (BMC). Usually, one of the BMCs is selected to be a master BMC. The master BMC controls the servers to start in a sequence, to reduce power consumption of the data center. The sequence is set according to a starting delay time set in a basic input output system (BIOS) of the BMC of each server. However, it is time-consuming to set the starting delay time in each of the large number of servers. Besides, if the master BMC is non-operational, the other servers cannot be started successfully.

### BRIEF DESCRIPTION OF THE DRAWINGS

FIG. 1 is a schematic diagram of one embodiment of a computing device and a data center.

FIG. 2 is a block diagram of one embodiment of function modules of a management unit of the computing device in FIG. 1.

FIG. 3 is a flowchart of one embodiment of a method for managing servers in the data center in FIG. 1.

FIG. 4 is a schematic diagram of one embodiment of an peripheral BMC list (as hereinafter described).

FIG. 5 is a schematic diagram of one embodiment of a master BMC list (as hereinafter described).

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

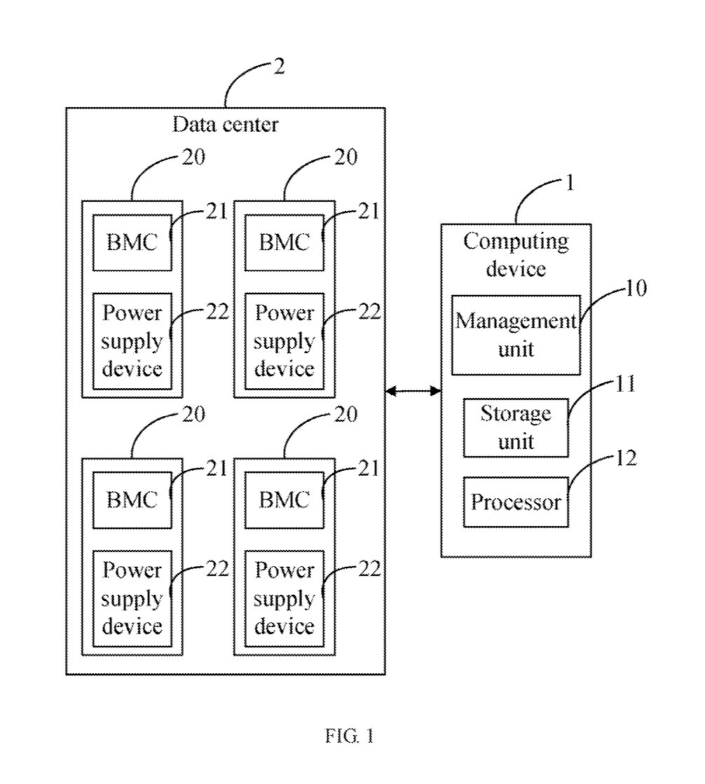

FIG. 1 is a schematic diagram of one embodiment of a computing device 1 and a data center 2. In the embodiment, the computing device 1 includes a management unit 10, a storage unit 11, and a processor 12. The computing device 1 is electrically connected to a data center 2. The data center 2 includes one or more servers 20 (four are shown in FIG. 1). Each server 20 includes a BMC 21 and a power supply device 22.

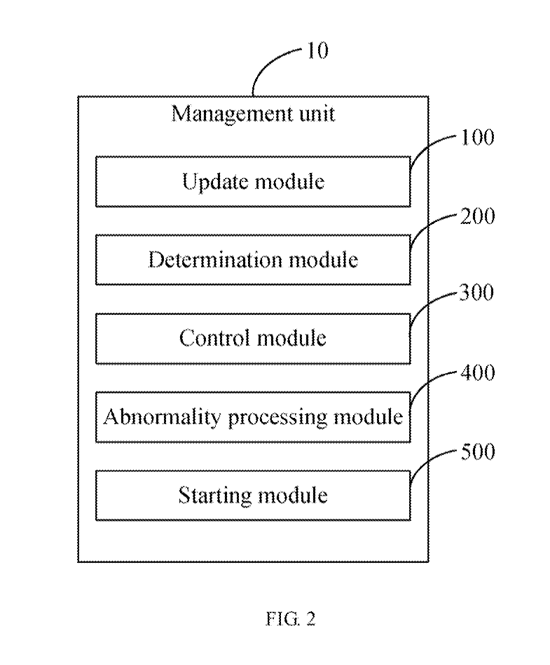

In one embodiment, the management unit 10 may include one or more function modules (as shown in FIG. 2). The one or more function modules may comprise computerized code in the form of one or more programs that are stored in the storage unit 11, and executed by the processor 12 to provide the functions of the management unit 10. The storage unit 11 is a dedicated memory, such as an EPROM or a flash memory.

The BMC 21 reads information (e.g., voltage data, electric current data, or electric power data) of the power supply device 22, and controls a power-on operation of the power supply device 22. The BMC 21 may be powered on by an external power source (not shown in FIG. 1), to which the server 20 is electronically connected. When the power supply device 22 is powered on, an operating system of a corresponding server 20 is started, so the server 20 starts to work.

In the embodiment, the BMCs 21 include candidate BMCs and peripheral BMCs. Candidate BMCs defines a group of BMCs of which any one may serve as a master BMC, and one of the candidate BMCs is selected to be a master BMC. Peripheral BMCs are the other BMCs which are not capable of serving as a master BMC. The candidate BMCs which are not selected to be the master BMC and the peripheral BMCs are controlled by the master BMC. The management unit 10 determines a master BMC from all of the candidate BMCs, the master BMC sends instructions to start the servers 20 to all of the peripheral BMCs, and the peripheral BMCs power on corresponding power supply devices 22 according to the instructions, to start corresponding servers 20. If the master BMC is non-operational, the management unit 10 selects another candidate BMC to be a new master BMC.

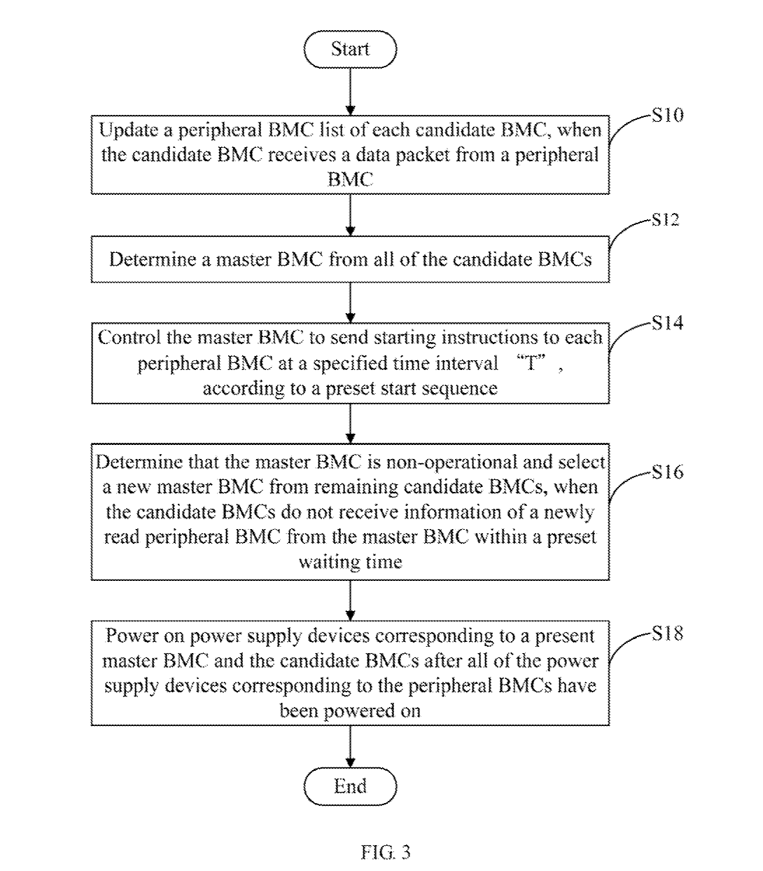

FIG. 2 is a block diagram of one embodiment of the function modules of the management unit 10. In one embodiment, the management unit 10 includes an update module 100, a determination module 200, a control module 300, an abnormality processing module 400, and a starting module 500. A description of the functions of the modules 100-500 is given with reference to FIG. 3.

FIG. 3 is a flowchart of one embodiment of a method for managing the servers 20 in the data center 2. Depending on the embodiment, additional steps may be added, others removed, and the ordering of the steps may be changed, all steps are labeled with even numbers only.

In the embodiment, each peripheral BMC records a historic average power Pᵢ using data from every time the server 20 starts, and sends a data packet including the historic average power Pᵢ to all of the candidate BMCs. The historic average power Pᵢ is an average value of the power consumed by the server 20 when the server 20 is started. For example, the first time that an peripheral BMC starts the corresponding server 20, the power of the server 20 may be 30 W, and the second time the peripheral BMC starts the server 20, the power of the server 20 may be 50 W, then the historic average power Pᵢ would be (30 W+50 W)/2=40 W.

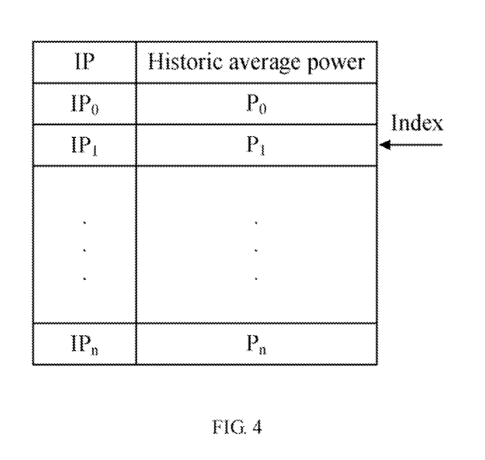

Each candidate BMC (including the determined master BMC) has a peripheral BMC list (as shown in FIG. 4). The peripheral BMC list is a data list, which includes one or more nodes, and each node records information of the peripheral BMCs. The information of each peripheral BMC includes an IP address of the peripheral BMC and the historic average power Pᵢ. The peripheral BMC list further includes an index “Index” that points to the node associated with a presently read peripheral BMC. The presently read peripheral BMC powers on the corresponding power supply device 22 according to the instruction of the master BMC.

In step S10, the update module 100 updates the peripheral BMC list of each candidate BMC, when the candidate BMC receives a data packet from an peripheral BMC.

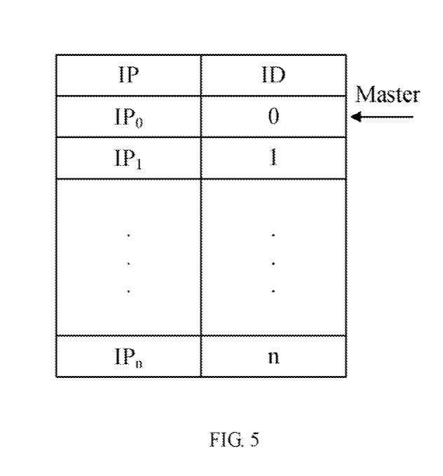

In step S12, the determination module 200 determines a master BMC from all of the candidate BMCs. In the embodiment, each candidate BMC (including the determined master BMC) further has a master BMC list (as shown in FIG. 5).

The master BMC list is a data list, which includes one or more nodes, and each node records information of the candidate BMCs (including the determined master BMC). The information of each candidate BMC includes an IP address of the candidate BMC and a preset identity number (ID, e.g., from “0” to “n”). The master BMC list further includes an index “Master” that points to the node associated with the determined master BMC. In the embodiment, the candidate BMC with the lowest identity number in the master BMC list is determined to be the master BMC. For example, the candidate BMC with an identity number “0” is initially determined to be the master BMC.

In step S14, the control module 300 controls the master BMC to send starting instructions to each peripheral BMC at a specified time interval “T”, according to a preset start sequence. Then each peripheral BMC powers on the corresponding power supply device 22, so that the corresponding server 20 is started. The master BMC further moves the index “Index” in the peripheral BMC list from the node associated with the presently read peripheral BMC to point to the node associated with a newly read peripheral BMC, and sends the information of the newly read peripheral BMC to each candidate BMC. The candidate BMCs then move the index “Index” in the peripheral BMC lists from the node associated with the presently read peripheral BMC to point to the node associated with the newly read peripheral BMC.

In the embodiment, the preset start sequence is set according to the historic average power Pᵢ in the peripheral BMC list. In other embodiments, the preset start sequence may be set according to an ascending numerical ID of each peripheral BMC, for example.

In step S16, the abnormality processing module 400 determines that the master

BMC is non-operational and selects a new master BMC from remaining candidate BMCs, when the candidate BMCs do not receive information of the newly read peripheral BMC from the master BMC within a preset waiting time. In the embodiment, if the master BMC with the identity number “0” is non-operational, the abnormality processing module 400 selects the candidate BMC with the next identity number (“1” in this case) to be the new master BMC.

In the embodiment, the preset waiting time is “3T”. The new master BMC continues to send starting instructions to remaining peripheral BMCs at the specified time interval “T”, according to the preset start sequence. The remaining peripheral BMCs are peripheral BMCs of which the corresponding power supply devices 22 have not been powered on. In other embodiments, the new master BMC also can send starting instructions to all of the peripheral BMCs.

The index “Master” in the master BMC list is moved from the node associated with the non-operational master BMC to point to the node associated with the new master BMC.

In step S18, the starting module 500 powers on the power supply devices 20 corresponding to a present master BMC (the master BMC or the new master BMC) and the candidate BMCs after all of the power supply devices 20 corresponding to the peripheral BMCs have been powered on. In the embodiment, the power supply devices 20 corresponding to the present master BMC and the candidacy BMCs are powered on according to a sequence of the identity number in the master BMC lists at the specified time interval “T”.

Although certain inventive embodiments of the present disclosure have been specifically described, the present disclosure is not to be construed as being limited thereto.

Various changes or modifications may be made to the present disclosure without departing from the scope and spirit of the present disclosure.

What is claimed is:

1. A computer-implemented method being executed by a processor of a computing device electrically connected to a data center, the data center comprising one or more servers, each server comprising a baseboard management controller (BMC) and a power supply device, the BMCs comprising candidate BMCs and peripheral BMCs, the method comprising:
(a) updating a peripheral BMC list of each candidate BMC, in response that the candidate BMC receives a data packet from the peripheral BMC;
(b) determining a master BMC from all of the candidate BMCs;
(c) controlling the master BMC to send starting instructions to each peripheral BMC at a specified time interval, according to a preset start sequence; and
(d) powering on the power supply devices corresponding to a present master BMC and the candidate BMCs after all of the power supply devices corresponding to the peripheral BMCs have been powered on.

2. The method as claimed in claim 1, wherein between step (c) and step (d) the method further comprises:
determining that the master BMC is non-operational and selecting a new master BMC from remaining candidate BMCs, in response that the candidate BMCs do not receive information of a newly read peripheral BMC from the master BMC within a preset waiting time.

3. The method as claimed in claim 1, wherein:
the peripheral BMC list includes one or more nodes, and each node records information of the peripheral BMCs;
the information of each peripheral BMC includes an IP address of the peripheral BMC and a historic average power of the server; and
the peripheral BMC list further includes a first index that points to a node of the peripheral BMC list associated with a presently read peripheral BMC.

4. The method as claimed in claim 3, wherein the preset start sequence is set according to the historic average power in the peripheral BMC list.

5. The method as claimed in claim 1, wherein:
each candidate BMC further comprises a master BMC list;
the master BMC list includes one or more nodes, and each node records information of the candidate BMCs;
the information of each candidate BMC includes an IP address of the candidate BMC and a preset identity number; and
the master BMC list further includes a second index that points to a node of the master BMC list associated with the determined master BMC.

6. The method as claimed in claim 5, wherein the candidate BMC with the lowest identity number in the master BMC list is determined to be the master BMC.

7. The method as claimed in claim 5, wherein in step (d), the power supply devices corresponding to the present master BMC and the candidate BMCs are powered on according to a sequence of the identity number in the master BMC lists at the specified time interval.

8. A non-transitory storage medium storing a set of instructions, the set of instructions being executed by a processor of a computing device electrically connected to a data center, the data center comprising one or more servers, each server comprising a baseboard management controller (BMC) and a power supply device, the BMCs comprising candidate BMCs and peripheral BMCs, to perform a method comprising:
(a) updating an peripheral BMC list of each candidate BMC, in response that the candidate BMC receives a data packet from the peripheral BMC;
(b) determining a master BMC from all of the candidate BMCs;
(c) controlling the master BMC to send starting instructions to each peripheral BMC at a specified time interval, according to a preset start sequence; and
(d) powering on the power supply devices corresponding to a present master BMC and the candidate BMCs after all of the power supply devices corresponding to the peripheral BMCs have been powered on.

9. The non-transitory storage medium as claimed in claim 8, wherein between step (c) and step (d) the method further comprises:
determining that the master BMC is non-operational and selecting a new master BMC from remaining candidate BMCs, in response that the candidate BMCs do not receive information of a newly read peripheral BMC from the master BMC within a preset waiting time.

10. The non-transitory storage medium as claimed in claim 8, wherein:
the peripheral BMC list includes one or more nodes, and each node records information of the peripheral BMCs;
the information of each peripheral BMC includes an IP address of the peripheral BMC and a historic average power of the server; and
the peripheral BMC list further includes a first index that points to a node of the peripheral BMC list associated with a presently read peripheral BMC.

11. The non-transitory storage medium as claimed in claim 10, wherein the preset start sequence is set according to the historic average power in the peripheral BMC list.

12. The non-transitory storage medium as claimed in claim 8, wherein:
each candidate BMC further comprises a master BMC list;
the master BMC list includes one or more nodes, and each node records information of the candidate BMCs;
the information of each candidate BMC includes an IP address of the candidate BMC and a preset identity number; and
the master BMC list further includes a second index that points to a node of the master BMC list associated with the determined master BMC.

13. The non-transitory storage medium as claimed in claim 12, wherein the candidate BMC with the lowest identity number in the master BMC list is determined to be the master BMC.

14. The non-transitory storage medium as claimed in claim 12, wherein in step (d), the power supply devices corresponding to the present master BMC and the candidate BMCs are powered on according to a sequence of the identity number in the master BMC lists at the specified time interval.

15. A computing device electrically connected to a data center, the data center comprising one or more servers, each server comprising a baseboard management controller (BMC) and a power supply device, the BMCs comprising candidate BMCs and peripheral BMCs, the computing device comprising:
a storage unit;
at least one processor;
one or more programs that are stored in the storage unit and are executed by the at least one processor, the one or more programs comprising:
a update module that updates an peripheral BMC list of each candidate BMC, in response that the candidate BMC receives a data packet from the peripheral BMC;
a determination module that determines a master BMC from all of the candidate BMCs;
a control module that controls the master BMC to send starting instructions to each peripheral BMC at a specified time interval, according to a preset start sequence; and
a starting module that powers on the power supply devices corresponding to a present master BMC and the candidate BMCs after all of the power supply devices corresponding to the peripheral BMCs have been powered on.

16. The computing device as claimed in claim 15, wherein the one or more programs further comprises:
an abnormality processing module that determines the master BMC is non-operational and selects a new master BMC from remaining candidate BMCs, in response that the candidate BMCs do not receive information of a newly read peripheral BMC from the master BMC within a preset waiting time.

17. The computing device as claimed in claim 15, wherein:
the peripheral BMC list includes one or more nodes, and each node records information of the peripheral BMCs;
the information of each peripheral BMC includes an IP address of the peripheral BMC and a historic average power of the server; and
the peripheral BMC list further includes a first index that points to a node of the peripheral BMC list associated with a presently read peripheral BMC.

18. The computing device as claimed in claim 17, wherein the preset start sequence is set according to the historic average power in the peripheral BMC list.

19. The computing device as claimed in claim 15, wherein:
each candidate BMC further comprises a master BMC list;
the master BMC list includes one or more nodes, and each node records information of the candidate BMCs;
the information of each candidate BMC includes an IP address of the candidate BMC and a preset identity number; and
the master BMC list further includes a second index that points to a node of the master BMC list associated with the determined master BMC.

20. The computing device as claimed in claim 19, wherein the candidate BMC with the lowest identity number in the master BMC list is determined to be the master BMC.

21. The computing device as claimed in claim 19, wherein the power supply devices corresponding to the present master BMC and the candidate BMCs are powered on according to a sequence of the identity number in the master BMC lists at the specified time interval.
